(19) United States
(12) Patent Application Publication
(10) Pub. No.: US 2013/0093945 A1
(43) Pub. Date: Apr. 18, 2013

(54) IMAGING APPARATUS

(71) Applicants: WATARU OKAMOTO, Osaka (JP); TAIZO AOKI, Hyogo (JP)

(72) Inventors: WATARU OKAMOTO, Osaka (JP); TAIZO AOKI, Hyogo (JP)

(73) Assignee: PANASONIC CORPORATION, Osaka (JP)

(21) Appl. No.: 13/414,130

(22) Filed: Mar. 7, 2012

(30) Foreign Application Priority Data
Oct. 13, 2011 (JP) 2011-225593

(51) Int. Cl. H04N 5/235

(52) U.S. Cl. 348/362; 348/E05.037

(57) ABSTRACT

An imaging apparatus includes a controller configured to calculate a target exposure value based on image data generated by an imaging unit and control an exposure to obtain the target exposure value based on a first shooting parameter set by a user, and a predetermined operation member for receiving operation of the user. The controller calculates a first appropriate range which is a range in which the first shooting parameter is settable for obtaining the target exposure value, calculates a second shooting parameter based on the target exposure value and the first shooting parameter set by the user, and performs an exposure control operation for setting the first shooting parameter within the first appropriate range, when the predetermined operation member receives user's operation in cases where the first shooting parameter set by the user is out of the first appropriate range.

### BACKGROUND

1. Technical Field

The technical field relates to an imaging apparatus for capturing an image of a subject and outputting moving image information, and more particularly to an imaging apparatus which allows a user to set an exposure thereon.

2. Related Art

A conventional imaging apparatus can allow a user to manually set an exposure condition (shooting parameter) of either one of an aperture value and a shutter speed to meet the user's preference. When the user sets one of the exposure conditions, such an imaging apparatus automatically sets the other exposure condition based on the set exposure condition to obtain an appropriate exposure setting (for example, JP07-333706A). For example, in an aperture priority AE (Automatic Exposure) mode, when the user sets the aperture value that is one of the shooting parameters, the shutter speed is automatically decided to obtain an appropriate exposure setting according to the aperture value and the brightness of the subject.

### SUMMARY

However, such a conventional imaging apparatus may set the exposure to be out of the appropriate range when the exposure condition is automatically set, depending on an exposure condition set by the user. In that case, the user bothers to manually change the shooting parameter to obtain an appropriate exposure setting.

For example, it is assumed that the user sets the aperture value to F2 in the aperture priority AE mode. If the subject's brightness is too high, overexposure may occur even when the imaging apparatus sets the shutter speed as fast as possible. The user needs to know the amount of an aperture value to be changed in order to obtain an appropriate exposure setting in such an overexposure condition. Further the user needs to operate the imaging apparatus to actually change the aperture value. Since it takes time and effort to change the shooting parameter to obtain an appropriate exposure setting like that, the user might miss a chance for a good shot.

In view of such poor convenience of the imaging apparatus, an imaging apparatus is provided that is capable of obtaining an appropriate exposure setting more easily and more quickly.

An imaging apparatus includes an imaging unit configured to capture an image of a subject to generate image data, a controller configured to calculate a target exposure value based on the image data and control an exposure to obtain the target exposure value based on a first shooting parameter set by a user, and a predetermined operation member for receiving operation of the user. The controller calculates a first appropriate range which is a range in which the first shooting parameter is settable for obtaining the target exposure value, calculates a second shooting parameter based on the target exposure value and the first shooting parameter set by the user, and performs an exposure control operation for setting the first shooting parameter within the first appropriate range, when the predetermined operation member receives user's operation in cases where the first shooting parameter set by the user is out of the first appropriate range.

According to the imaging apparatus, even when an appropriate exposure cannot be obtained from a shooting parameter set by the user, the appropriate exposure can be automatically obtained. Further, a shooting parameter as close as possible to the user's intention can be automatically obtained in response to a user's operation on a predetermined operation member. That allows the user to obtain the appropriate exposure more easily and more quickly.

### BRIEF DESCRIPTION OF DRAWINGS

FIG. 1 is a block diagram showing a configuration of a digital camera.

FIG. 2 is a flow chart for describing a series of operations including an exposure control operation and a shooting parameter display operation of a digital camera.

FIG. 3 is a diagram for describing an Ev correction value.

FIG. 4 is a diagram showing relationship among an Ev value, an Av value, and a Tv value.

FIG. 5 is a flow chart for describing an exposure control operation.

FIG. 6 is a diagram showing an available setting range of shooting parameter.

FIG. 7 is a flow chart showing a method of deciding an available setting range of Av value and a Tv value in an A mode.

FIG. 8 is a flow chart showing a method of deciding an available setting range of Tv value and the Av value in an S mode.

FIGS. 9A and 9B are diagrams showing operations of a display unit that displays shooting parameters when an appropriate exposure is set.

### DETAILED DESCRIPTION OF PREFERRED EMBODIMENT

A digital camera according to a preferred embodiment will be described below with reference to the accompanying drawings.

The digital camera of the embodiment to be described below is capable of changing the aperture value or the shutter speed to obtain an appropriate exposure in an aperture priority AE mode or a shutter speed priority AE mode, by only user's pressing of a button. This function is effective for cases where the user has decided what kind of photograph the user wants to take. One example case is when the user wants to take a photograph with the aperture value as close as possible to the open side. The configuration and the operations of the digital camera of the embodiment will be described in detail below.

### 1. Configuration of Digital Camera

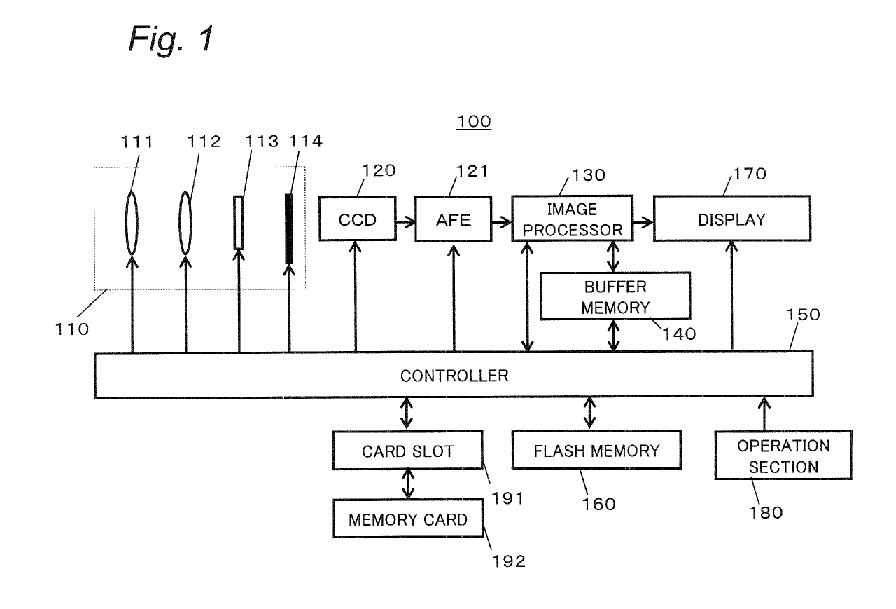

The configuration of the digital camera of the embodiment will be described with reference to FIG. 1. The digital camera 100 captures a subject's image formed through an optical system 110 with a CCD image sensor (imaging unit) 120. The CCD image sensor 120 generates image data based on the captured subject's image. The generated image data is subjected to several types of image processing in an AFE (Analog Front End) 121 or an image processor 130. The image data subjected to the image processing is recorded on a flash memory 160 or a memory card 192. The image data recorded on the flash memory 160 or the memory card 192 is reproduced and displayed on a display unit 170 such as a display unit (LCD) when the operation section 180 receives an operation for instructing playback made by the user.

The optical system 110 includes a focus lens 111, a zoom lens 112, an aperture 113, and a shutter 114. The optical system 110 may include a camera-shake correction lens OIS (Optical Image Stabilizer). The respective lenses composing the optical system 110 may be composed of any number of lenses or any groups of lenses.

The focus lens 111 adjusts the focal distance. The zoom lens 112 adjusts the magnification of an image formed by the CCD image sensor 120. The aperture 113 adjusts amount of light incident to the CCD image sensor 120. It is assumed that an available setting range of aperture value for the aperture 113 is from F4 to F22. The shutter 114 adjusts the exposure time of light incident to the CCD image sensor 120. It is assumed that an available setting range of shutter speed for the shutter 114 is from 60 seconds to 1/4000 seconds. The focus lens 111, the zoom lens 112, the aperture 113, and the shutter 114 are driven by the respective driver such as a DC motor and a stepping motor (not shown) according to control signals sent from a controller (control unit) 150.

The CCD image sensor 120 captures the subject image formed through the optical system 110 to generate image data. The CCD image sensor 120 generates a new frame of image data for every certain period of time (for example, every 1/30 seconds). The CCD image sensor 120 adjusts the amount of exposed light by an electronic shutter operation. Another imaging device such as a CMOS image sensor or an NMOS image sensor may be used in place of the CCD image sensor 120.

The AFE 121 executes predetermined processing such as correlated double sampling and gain control on the image data generated by the CCD image sensor 120. A gain according to an ISO sensitivity is set in the gain control. The AFE 121 converts analog image data to digital image data. Then, the AFE 121 outputs the image data to the image processor 130.

The image processor 130 performs various types of image processing on the image data. The various types of image processing includes, a correction, white balance correction, YC conversion process, electronic zoom process, compression process, and decompression process. Some of these types of processing may be omitted. The image processor 130 may be constituted of a hardwired electronic circuit or a microcomputer or the like that executes a program for performing these types of processing. The image processor 130 may also be constituted of a single integrated circuit together with the controller 150 and the like.

The operation section 180 includes a button, a lever, a dial and the like provided on an exterior of the digital camera 100, and receives user's operations with them. For example, the operation section 180 includes a release button, a zoom lever, a mode dial, a command dial, a directional button, a power switch, a function button, and the like. The user can make the digital camera 100 perform an appropriate exposure setting operation for changing the exposure setting to obtain an appropriate exposure based on the current exposure setting by pressing a function button. The operation section 180 also includes a focus ring and a zoom ring provided on the lens-barrel and a touch panel provided on the display unit 170. When the operation section 180 receives user's operation, it sends an operation instructing signal according to the user's operation to the controller 150.

The display unit 170 is provided on the back of the digital camera 100. The display unit 170 displays an image based on the image data processed by the image processor 130. The display unit 170 displays the images such as a through image and a recorded image. The display unit 170 is capable of displaying images generated by the CCD image sensor 120 for every certain period of time as the through image almost in real time. By viewing the through image di splayed on the display unit 170, the user can take a photograph while checking the composition of the subject. The recorded image is an image recorded in the memory card 192 or the flash memory 160. The display unit 170 displays an image based on the image data recorded in the memory card 192 or the flash memory 160 according to the user's operation. Other than images, the display unit 170 can also display respective shooting parameters. The shooting parameters include an aperture value and a shutter speed, and may also include an ISO sensitivity and an exposure correction value. The display unit 170 superimposes and displays these shooting parameters on the through image. Besides, the display unit 170 can display various setting conditions and the like of the digital camera 100.

The controller 150 controls the operations of the digital camera 100. The controller 150 is composed of a ROM (not shown) that stores information on, for example, a program, a CPU (not shown) that processes the information on the program, and the like. The ROM stores programs related to focus control and exposure control as well as programs for controlling the operations of the digital camera 100. The ROM stores imaging initial data about the aperture value and the shutter speed to perform capturing for the first time after the COD image sensor 120 is activated, and data about the target brightness value for obtaining the appropriate exposure. The ROM also stores information on a diagram showing relationship between the exposure value (Ev), the aperture value (Av), and the shutter speed (Tv) in the APEX (Additive System of Photographic Exposure) system. In the APEX system, the formula is shown below in view of the brightness of field (Bv) and the ISO sensitivity (Sv).

Ev=Av+Tv=Bv+Sv (1)

The controller 150 can control the display section 170 to display a menu. The user can operate the operation section 180 to perform various settings while viewing the menu displayed on the display section 170. The controller 150 acquires information set on the menu by the user.

For example, the controller 150 acquires a recording mode set by the user's operation on the operation unit 180. The recording mode includes a P mode (program AE mode), an A mode (aperture priority AE mode), an S mode (shutter speed priority AE mode) and an M mode (manual exposure mode), but may include other recording modes. In the first embodiment, an exposure guide is displayed on the display section in the A mode and the S mode, and the following explanation is made mainly to these two recording modes.

In each mode, the shooting parameters are set by the user and/or the controller 150. The shooting parameters to be set by the user are set by the user via the operation section 180. In this case, the controller 150 calculates and sets residual shooting parameters using the parameters set by the user's operation. The controller 150 sets the shooting parameters according to the recording mode. For example, in the P mode, the controller 150 calculates the aperture value and the shutter speed according to the brightness value of the through image. In the A mode, the controller 150 calculates and sets the shutter speed using the aperture value set by the user and according to the brightness value of the through image. In the S mode, the controller 150 calculates the aperture value according to the shutter speed set by the user and the brightness value of the through image. In the M mode, the user sets all the shooting parameters.

In each mode, the ISO sensitivity is set by the user's operation on the operation section 180. The controller 150 sets a gain in a gain control of the analog front end 121 according to the set ISO sensitivity. In the first embodiment, the ISO sensitivity is set by the user, but the controller 150 may control the ISO sensitivity in the P mode, the A mode and the S mode.

The controller 150 generates image data of the exposure guide for showing the shooting parameters and so on to the user based on the set respective shooting parameters and di splays the image data on the display section 170.

The controller 150 may include a hard-wired electronic circuit, a microcomputer, or the like. Further, the controller 150 as well as the image processor 130 may be constituted as one integrated circuit. The ROM does not have to be provided in the controller 150, but may be provided outside the controller 150.

A buffer memory 140 is a storage unit that functions as a work memory of the image processor 130 and the controller 150. The buffer memory 140 can be realized by a DRAM (Dynamic Random Access Memory), or the like.

The flash memory 160 functions as an internal memory for recording image data or the like. The controller 150 records image data to be processed by the image processor 130 in the flash memory 160 or the memory card 192.

A card slot 191 is a connecting unit for attaching the memory card 192 to the digital camera 100. The card slot 191 can be electrically or mechanically connected to the memory card 192. The card slot 191 may have a function for controlling the memory card 192.

The memory card 192 is an external memory having therein a memory device such as a flash memory. The memory card 192 can record data such as image data to be processed by the image processor 130. In the first embodiment, the memory card is described as one example of an external memory, but a recording medium such as an optical disk and a HDD may be used as the external memory. Further, a communication interface (wireless or wired) for communicating with a device outside the digital camera 100 may be connected to the controller 150 so that image data is transmitted to the outside device.

### 2. Operation of Digital Camera

The operations of the digital camera 100 of the embodiment will be described below.

### 2-1. Outline of Operation

First, the exposure control operation of the digital camera 100 will be described. The “exposure control operation” is an operation of the digital camera 100 to set the shooting parameter other than parameter(s) which the user sets, based on the parameter(s) which the user sets. The operation of the digital camera 100 performed when the user takes a photograph with one of the A mode and the S mode selected as the recording mode will be described below.

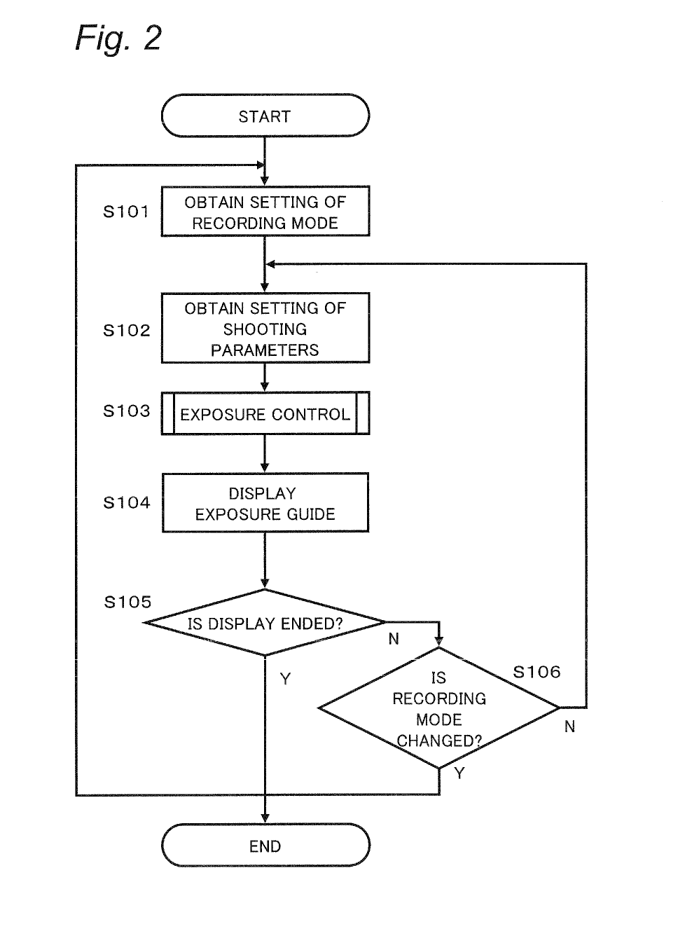

A series of operations including an exposure control operation and a shooting parameter display operation of a digital camera 100 in the A mode or the S mode will be outlined with reference to FIG. 2. First, prior to taking a picture, the user operates the operation section 180 to set the recording mode. When the operation section 180 has a mode di al or a button dedicated to the recording mode, the user operates the mode dial or the button. When the operation section 180 does not have the dedicated mode dial or button, the user presses down the menu button of the operation section 180 so as to display the menu, and sets the recording mode on the menu. The controller 150 acquires information indicating the recording mode set by the user (S101).

Next, the user turns the digital camera 100 to a subject and operates the operation section 180 according to brightness of the subject to set the shooting parameter such as an aperture value and a shutter speed. Concretely, when the image mode is the A mode (aperture priority AE mode), the user sets the aperture value, and when it is the S mode (shutter speed priority AE mode), the user sets the shutter speed. When the user does not particularly perform an operation, the aperture value and the shutter speed are not changed. The controller 150 acquires information indicating the shooting parameter such as the aperture value or the shutter speed set by the user (S102). Further, the user adjusts a zoom and a focus as needed. The controller 150 suitably controls the optical system 110 according to user's operation.

The controller 150 controls the exposure based on the respective modes (S103). Specifically, in the A mode (aperture priority AE mode), the controller 150 calculates and sets the shutter speed and the like based on the brightness value and the like of the through image and the aperture value set by the user. In the S mode (shutter speed priority AE mode), the controller 150 calculates and sets the aperture value and the like based on the brightness value and the like of the through image and the shutter speed set by the user. At that time, if the controller 150 detects that a function button of the operation section 180 is pressed, the controller 150 performs an appropriate exposure setting operation. The “appropriate exposure setting operation” is an operation of the controller 150 for changing the shooting parameter set by the user to obtain an appropriate exposure. The exposure control operation and the appropriate exposure setting operation will be described in detail later.

Next, the controller 150 displays the current shooting parameters such as the aperture value or the shutter speed on the display unit 170 as the exposure guide (S104). It is assumed that, as the shooting parameter, the aperture value is displayed in the A mode and the shutter speed is displayed in the S mode. However, all the shooting parameters may be displayed.

Next, the controller 150 judges whether or not to finish the display of the shooting parameters (S105). The timing to finish the display includes (1) a timing when the user presses the release button to start photographing or (2) a timing when the user changes the recording mode to the other mode than the A and S modes.

If the controller 150 judges to finish display of the exposure guide (shooting parameters) (“Y” in S105), the controller 150 finishes the di splay of the exposure guide (hidden in the display unit 170) and finishes the process. On the other hand, if the controller 150 judges to continue the display of the shooting parameters (“N” in S105), it judges whether the recording mode has been changed by the user (S106). If the recording mode has been changed (“Y” in S106), the controller 150 returns to the state of obtaining the information on the recording mode (S101). On the other hand, if the recording mode has not been changed (“N” in S106), the controller 150 returns to the state of obtaining the information on the shooting parameter (S102). The series of operations (S101 to S106) is performed every period for which the CCD image sensor 120 captures the subject and outputs the image data (for example, 1/30 seconds).

### 2-2. Exposure Control Operation

### 2-2-1. Outline of Exposure Control Operation

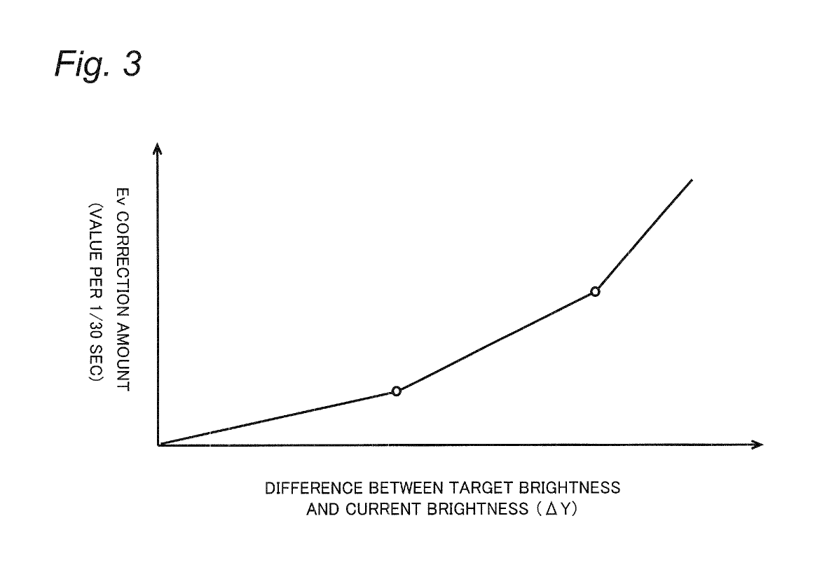

The exposure control operation of the digital camera 100 will be described with reference to FIGS. 3, 4, and 5.

FIG. 3 is a diagram for describing the Ev correction amount that is decided for the difference ΔY between a target brightness value and the current brightness value. The “target brightness value” is a brightness required for obtaining the appropriate exposure. The “current brightness value” is the brightness value calculated from the generated image data. ΔY is calculated by the formula ΔY=(the current brightness value)−(the target brightness value). The axis of abscissa shows ΔY and the axis of ordinate shows the Ev correction amount. The digital camera 100 increases the Ev correction amount larger as ΔY is larger. That is, the digital camera 100 decides the Ev correction amount so that the exposure decreases as the current brightness value exceeds more than the target brightness value.

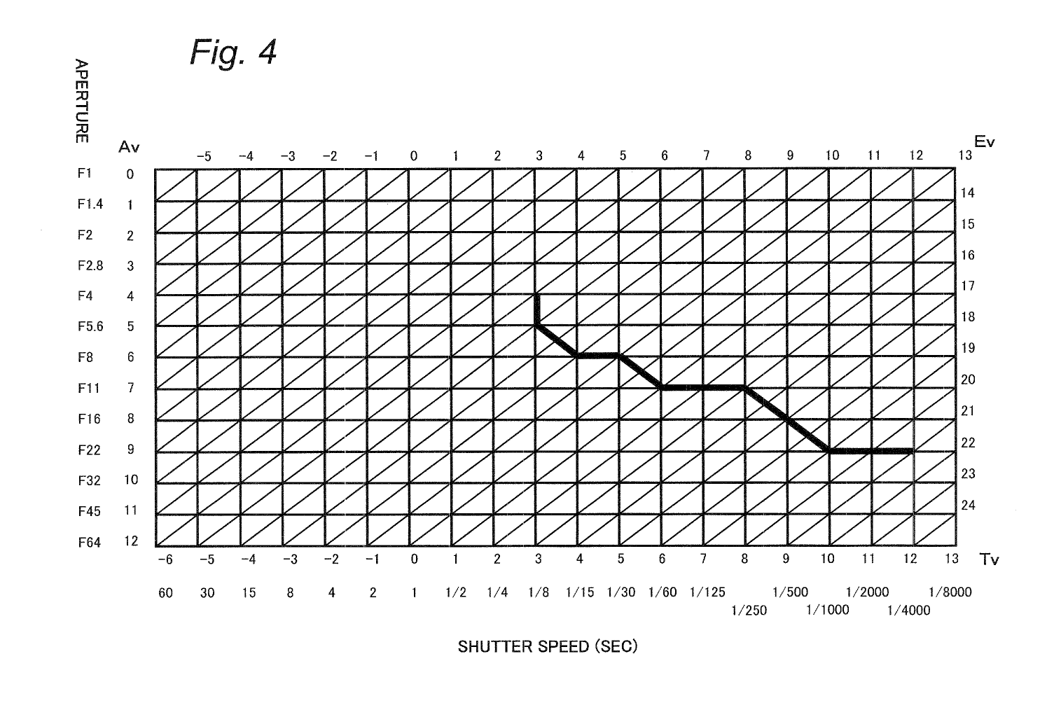

FIG. 4 is a diagram illustrating a relationship among the Ev value, the Av value and the Tv value in the APEX system. The Tv value is plotted along an abscissa axis, and the Av value is plotted along an ordinate axis. FIG. 4 also illustrates correspondence between the Tv value and an actual shutter speed (second) and correspondence between the Av value and an actual aperture value (F value). Each of diagonally right up lines show the same Ev value, and the Ev value is shown on an upper and right sides of the graph. Av value and Ev value are associated with one another according to “Ev=Tv+Av” of the “formula 1”. A thick polygonal line represents a program line in the P mode set in the digital camera 100. That is, the thick broken line is the track of the Tv value and the Av value set by the digital camera 100 for each Ev value.

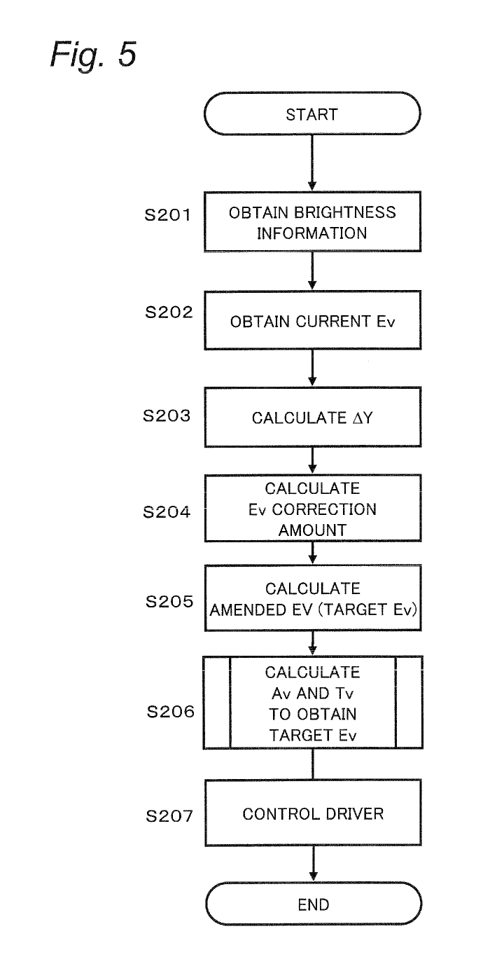

FIG. 5 is a flowchart illustrating the exposure control operation. The controller 150 corrects an exposure value every one frame period (every 1/30 seconds) for which image data is generated, according to the flow chart so that suitable exposure can be obtained. The exposure control operation of the digital camera 100 will be described in detail below with reference to FIG. 5.

The controller 150 obtains brightness information from image data every time the image data of a new frame is generated (S201). Exemplary methods for calculating the brightness information include a method for obtaining average brightness of respective pixels in a predetermined range on a center portion of the image as brightness information (spot metering), and a method for dividing the entire image data into a plurality of blocks and weighted-averaging the blocks based on average brightness of the blocks so as to obtain brightness information (multi metering). The method for calculating the brightness information may be preset to one of the above described methods or may be set by the user on the menu when taking a photograph.

The controller 150 controls the Ev value to bring the value (referred to as “brightness value”) indicated by the obtained current brightness information to the target brightness value stored in the ROM (referred to as “exposure control”). Although it is assumed that the value stored in the ROM is used as the target brightness value, the target brightness value may be changed by an exposure correction function of the digital camera 100 if the camera has the exposure correction function.

Next, the controller 150 obtains the current Ev value (S202). The current Ev value is decided according to the current Av value and Tv value. Here, it is assumed that the Ev value immediately after the digital camera 100 is powered on, i.e., the Ev value at the moment when the CCD image sensor 120 starts generating the image data, is set based on the initial data about the aperture value and the shutter speed stored in the ROM.

The controller 150 calculates the difference ΔY between the target brightness value and the current brightness value (S203), and calculates the Ev correction amount from ΔY based on the relationship shown in FIG. 3 (S204). Then, the controller 150 calculates the corrected Ev value (hereinafter referred to as “target Ev value” or “target exposure value”) from the current Ev value and the Ev correction amount (S205).

The controller 150 decides the Av value (aperture value) and the Tv value (shutter speed) for obtaining the target Ev value (target exposure value) with reference to a diagram as shown in FIG. 4 (S206).

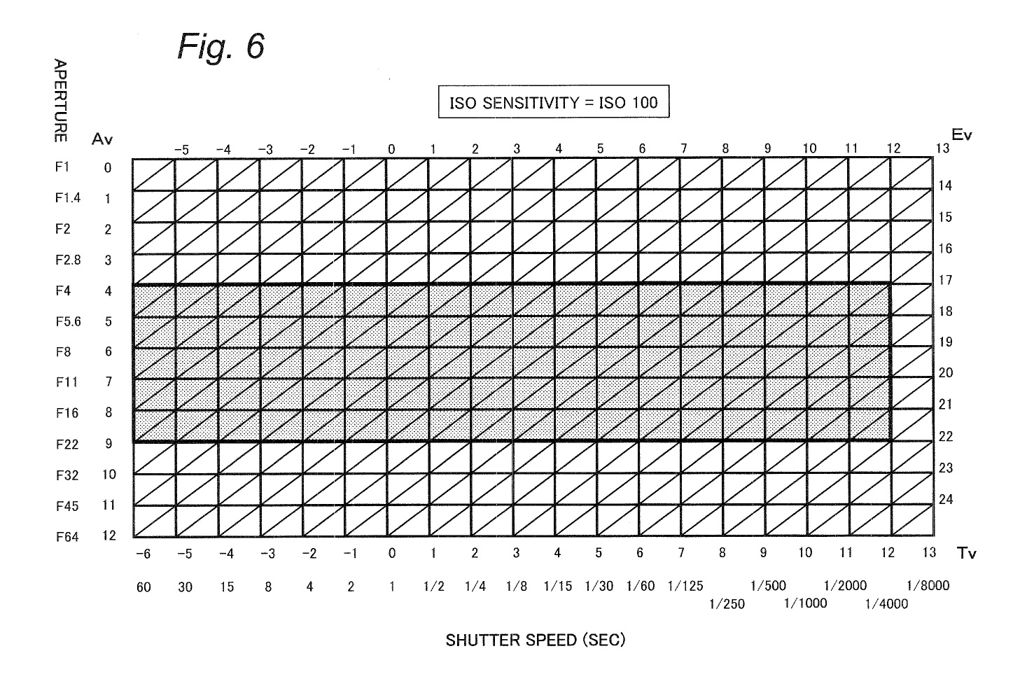

FIG. 6 is a diagram for describing an available setting range of camera. The “available setting range of camera” is a range of settable shooting parameters, which depends on the optical and mechanical performance of the hardware and the like that compose the digital camera 100. What the axis of abscissa shows and what the axis of ordinate shows are the same as those in FIG. 4. The shaded area of the figure shows the available setting range of camera. For example, if the ISO sensitivity is ISO100, the available setting range of aperture value is from F4 to F22 (from 4 to 9 in the Av value) and the available setting range of shutter speed is from 1/4000 to 60 seconds (from 12 to −6 in the Tv value).

The controller 150 references such a diagram as shown in FIG. 4 or 6 to find a combination of the aperture value and the shutter speed from the Ev value for deciding the Av value and the Tv value corresponding to the target Ev value. By referencing such a diagram, the controller 150 only needs to select one of the combinations of shooting parameters which can provide the target Ev value within the range of shooting parameters available for the digital camera 100. That is, the controller 150 selects one of the combinations of shooting parameters from the points where the positive slope corresponding to the target Ev value intersects with the available setting range of camera. The method of selecting the shooting parameter depends on the mode. As the range of shooting parameter available for the digital camera 100, i.e., the available setting range of shooting parameter, the aperture value is from F4 to F22 and the shutter speed is from 60 seconds to 1/4000 seconds, which mean the Av value ranges from 4 to 9 and the Tv value ranges take from −6 to 12. The information on these available setting ranges is stored in the ROM, and the controller 150 reads out the pieces of information from the ROM for use as required.

For example, in the P mode, the controller 150 performs the exposure controlling based on the program line in the diagram shown in FIG. 4. That is, the controller 150 calculates the Av value and the Tv value from the point where the line of the target Ev value decided by the controller 150 crosses the program line. For example, according to the program line, if the current Ev value is 13, the Av value is 7 and the Tv value is 6. Then, if the Ev correction amount calculated based on the difference ΔY between the target brightness value and the current brightness value is −2, the target Ev value is 11 (=13-2). Therefore, it is understood that the Av value needs to be corrected to 6 and the Tv value needs to be corrected to 5 to obtain the target Ev value.

Returning to FIG. 5, the controller 150 decides the shooting parameters as described above. The controller 150 sends the signals for driving the aperture 113, the shutter 114, and the CCD image sensor 120 according to the shooting parameters, to the respective drivers (not shown) (S207). If the shooting parameters which can provide the appropriate exposure are within the available setting range of camera, the controller 150 executes the exposure control operation for each frame period. The exposure control operation brings the brightness value of the image data to the target brightness value, so that the current exposure value provides the appropriate exposure.

The method of deciding the Av value and the Tv value in each of the A mode and the S mode will be described in detail below.

### 2-2-2. Method of Deciding Shooting Parameter in A Mode

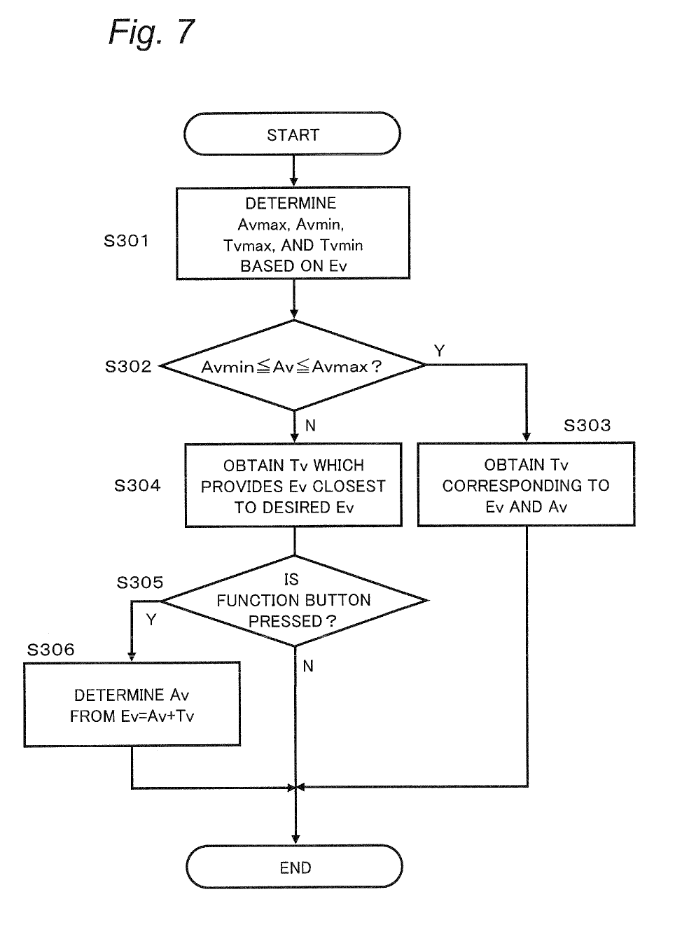

The method of deciding the available setting range of Av value and the Tv value in the A mode (aperture priority AE mode) will be described with reference to the flow chart of FIG. 7. In the A mode (aperture priority AE mode), the Av value is set by the user, and the controller 150 decides the Tv value according to the Av value.

In the A mode, since the Av value is fixed to the value set by the user, the controller 150 only decides the Tv value. Regardless of the user's setting, the controller 150 also obtains the available setting range of Av value to obtain the target Ev value. A specific example will be described below by assuming that the target Ev value is 13 and the aperture value set by the user is F5.6 (Av value is 5).

First, the controller 150 finds the available setting range of the shooting parameter (Av value, Tv value) based on the target Ev value (S301). For that purpose, the controller 150 references the diagram as shown in FIG. 6. As the available setting range of the Av value and the Tv value is the shaded area in the diagram of FIG. 6, it is enough to decide the area available for the Av value and the Tv value for obtaining the target Ev value (the upper limit, the lower limit). Here, the upper limit of the Av value is Avmax, the lower limit of the Av value is Avmin, the upper limit of the Tv value is Tvmax, and the lower limit of the Tv value is Tvmin. With reference to FIG. 6, it is found that Avmin=4 (Tvmax=9), and Avmax=9 (Tvmin=4) when the Ev value is 13. The approach for finding the available setting range of the Av value and the Tv value is the same as finding the unavailable or unsettable setting range of the Av value and the Tv value.

Next, whether the Av value corresponding to the current aperture value set by the user is within the available setting range or not, i.e., equal to or more than Avmin and equal to or less than Avmax or not is judged (S302). If the value is within the available setting range (“Y” in S302), the controller 150 finds the Tv value corresponding to the combination of the target Ev value and the Av value set by the user from the diagram of FIG. 6 (S303) and ends the process.

On the other hand, if the Av value corresponding to the current aperture value set by the user is out of the available setting range (“N” in S302), then the controller 150 finds the Tv value which achieves the Ev value closest to the target Ev value in the available setting range of camera with the Av value set by the user being used (S304).

Also at the same time, the controller 150 judges whether the function button of the operation section 180 is operated or not (S305). If the function button is not operated (“N” in S305), the controller 150 ends the process. If the function button is operated (“Y” in S305), the controller 150 changes the Av value to fulfill both the Tv value which is decided when the Av value set by the user is out of the available setting range for obtaining the target Ev value (S304) and the target Ev value (S306), and ends the process. The operation for automatically changing the shooting parameters set by the user to the appropriate value as described above (S306) is called the “appropriate exposure setting operation”. The appropriate exposure setting operation will be described in detail later.

In this example, since Avmin=4, Avmax=9, and the aperture value set by the user is 5 as the Av value, this Av value is within the available setting range for obtaining the target Ev value (“Y” in S302). Therefore, the controller 150 obtains 8 as the Tv value corresponding to the combination of 13 as the target Ev value and 5 as the Av value by referencing the diagram of FIG. 6.

From the above described processing, the available setting range of the Av value (Avmax=9, Avmin=4), and the Tv value (=8) corresponding to the user-set Av value in the A mode are found for obtaining the target Ev value (=13).

### 2-2-3. Method of Deciding Shooting Parameter in S Mode

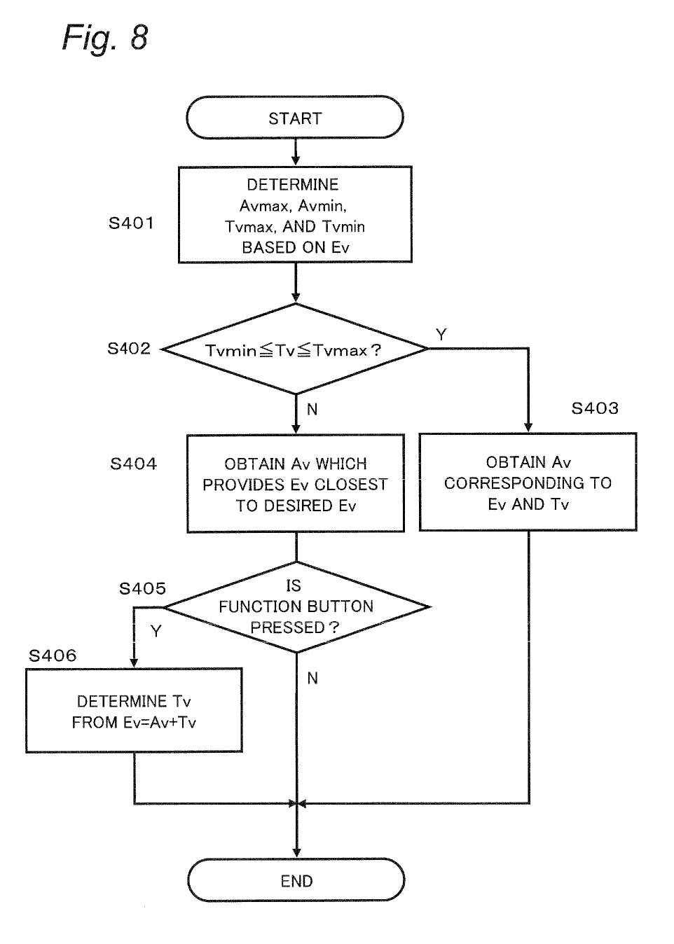

The method of deciding the available setting range of Tv value and the Av value in the S mode (shutter speed priority AE mode) will be described with reference to the flow chart of FIG. 8. In the S mode, since the Tv value is fixed to the value set by the user, the controller 150 only decides the Av value. Regardless of the user's setting, the controller 150 also obtains the available setting range of Tv value to obtain the target Ev value. A specific example will be described below by assuming that the target Ev value is 13 and the shutter speed set by the user is 1/2000 seconds (the Tv value is 11).

First, the controller 150 finds Avmax, Avmin, Tvmax, and Tvmin by referencing such a diagram as shown in FIG. 6 (S401). As the target Ev value is 13, it is found that Avmin=4 (Tvmax=9), and Avmax=9 (Tvmin=4).

Next, the controller 150 judges whether the Tv value corresponding to the current shutter speed set by the user is within the available setting range for obtaining the target Ev value (equal to or more than Tvmin and equal to or less than Tvmax) (S402). If the value is within the available setting range (“Y” in S402), the controller 150 finds the Av value corresponding to the combination of the target Ev value and the Tv value set by the user from the diagram of FIG. 6 (S403) and ends the process.

On the other hand, if the Tv value corresponding to the current shutter speed set by the user is out of the available setting range (“N” in S402), the controller 150 finds the Av value which achieves the Ev value closest to the target Ev value in the available setting range of camera with the user-set Tv value being used (S404).

In this example, although the Tv value corresponding to the shutter speed set by the user is 11, the available setting range of Tv value for obtaining the target Ev value is from 4 to 9. That is, the user-set Tv value is out of the available setting range (“N” in S402). Therefore, the controller 150 finds the Av value within the available setting range of camera so as to cause the Ev value to be closest to the target Ev value (=13) with reference to the diagram as shown in FIG. 6 with the Tv value fixed to 11. This value is found by finding the Av value which makes the absolute value of the difference between the target Ev value and the current Ev value minimum within the Av value setting range. That is described by using a formula as below. The following formula is obtained where the difference between the target Ev value and the current Ev value is ΔEv.

$$\begin{matrix}Δ Ev = \vert ( target Ev value ) - ( current Ev value ) \vert \\ = \vert 13 - ( Av + Tv ) \vert\end{matrix}$$

Since Tv=11, the formula is expressed as follows.

ΔEv=|13−Av−11|

|2−Av|

Since the available setting range of Av value is 4 Av 9, the Av value to provide the minimum LEv is found to be 4. Therefore, the controller 150 sets the Av value to 4 in this example (S404).

Also at the same time, the controller 150 judges whether the function button of the operation section 180 is operated or not (S406). If the function button is not operated (“N” in S405), the controller 150 ends the process. If the function button is operated (“Y” in S405), the controller 150 performs the appropriate exposure setting operation and changes the Tv value to the value which fulfills both the target Ev value and the Av value which is obtained in S404 (S406), and ends the process. The appropriate exposure setting operation in the S mode will be described in detail later.

From the above described processing, the available setting range of the Tv value (Tvmax=9, Tvmin=4) and the Av value (=4) corresponding to the Tv value set by the user are found for obtaining the target Ev value (=13). Accordingly, the Ev value is found to be 15 (=Av+Tv=4+11).

The Ev value in this example is 15, and higher than 13 of the target EV value. If the function button is not operated (“N” in S405), the image is captured with the Ev value (=15) as it is. Therefore, the shutter speed set by the user cannot provide the appropriate exposure and the obtained Ev value becomes higher than the target Ev value, resulting in the underexposure (the image is darker than that taken with appropriate exposure). When the obtained Ev value is lower than the target Ev value, the overexposure (the image is brighter than that taken with appropriate exposure) occurs.

As described above, if the function button is not operated, no appropriate exposure setting operation is performed and the Ev value is set to the value which is different from the target Ev value and which causes the underexposure. On the other hand, if the function button is operated, the appropriate exposure setting operation is performed, and the shooting parameter set by the user (in this example, the shutter speed, i.e., the Tv value) is changed to the value that provides the target Ev value. The appropriate exposure setting operation will be described below.

### 2-3. Appropriate Exposure Setting Operation

The appropriate exposure setting operation will be described which is performed when the shooting parameter (Av value, Tv value) set by the user is out of the available setting range for obtaining the target Ev value and the function button is pressed.

When the function button is pressed, the controller 150 performs the appropriate exposure setting operation and automatically changes the shooting parameter to obtain the appropriate exposure according to the recording mode. The shooting parameter which is automatically changed by the controller 150 is a parameter which should be manually set by the user in the mode. The shooting parameter is changed to fulfill (target Ev value)=Av+Tv.

Specifically, if the function button of the operation section 180 is operated when the user's setting cannot provide the appropriate exposure (“N” in step S302 of FIG. 7 or “N” in step S402 of FIG. 8), the controller 150 performs the appropriate exposure setting operation. In the A mode (aperture priority AE mode), the aperture value is changed, and in the S mode (shutter speed priority AE mode), the shutter speed is changed.

The procedure of changing the shooting parameter in the appropriate exposure setting operation differs for each recording mode. The appropriate exposure setting operation in each of the A mode and the S mode will be described in detail below.

### 2-3-1. Appropriate Exposure Setting Operation in A Mode

(1) When the Av Value is Lower than the Available Setting Range which Provides The Appropriate Exposure

The operation of the controller 150 will be described which is performed when the recording mode is the A mode and the aperture value is set to the value lower than the range which can provide the appropriate exposure. It is assumed that the target Ev value is 17 and the aperture value set by the user is F4 (Av value is 4). Avmax, Avmin, Tvmax, and Tvmin corresponding to the target Ev, 17, are 9, 5, 12, and 8, respectively. Therefore, the Av value, 4, which is set by the user is lower than the range. Therefore, the controller 150 obtains the Tv value (the Tv value is 12) to cause the current Ev value to be closest to the target Ev value with reference to the diagram of FIG. 6 (S304 of FIG. 7). Specifically, the Tv value is found as shown below.

$$\begin{matrix}Δ Ev = \vert ( target Ev value ) - ( current Ev value ) \vert \\ = \vert 17 - ( Av + Tv ) \vert \\ = \vert 17 - 4 - Tv \vert \\ = \vert 13 - Tv \vert\end{matrix}$$

Since the available setting range of Tv value is 8 Tv 12, the Tv value to provide the minimum ΔEv is found to be 12.

The obtained Ev value (=16) is lower than the target Ev value (=17), and thus the overexposure occurs. If the controller 150 detects that the function button is pressed in the above described occasion, the controller 150 changes the Av value to fulfill both the target Ev value and the obtained Tv value. In this case, since (Av value)=(target Ev)−(Tv value)=17-12=5, the Av value is changed from 4 to 5 (S306 of FIG. 7).

The above described appropriate exposure setting operation of the controller 150 brings the Av value to 5 and the Tv value to 12, which make the obtained Ev value (=17) equal to the target Ev value (=17), providing the appropriate exposure.

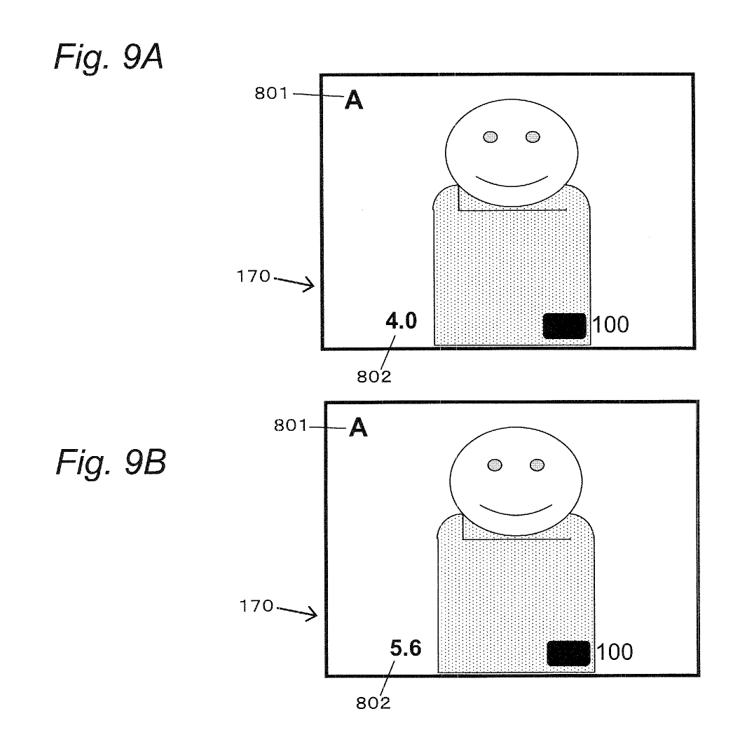

FIGS. 9A and 9B are diagrams showing operations of a display unit 170 that displays the shooting parameters when an appropriate exposure is set. FIG. 9A shows the state before the appropriate exposure setting operation of the controller 150 changes the screen display of the shooting parameters, anda FIG. 9B shows the state after the change. FIGS. 9A and 9B show screen displays in the A mode as an example. The display unit 170 superimposes the icon 801 showing the current recording mode and the current shooting parameter 802 on the through image. FIG. 9A shows the state before the function button is pressed, i.e., when the aperture value is F4 (the Av value is 4) which does not provide the appropriate exposure. When the function button is pressed in that state, the controller 150 performs the appropriate exposure setting operation and changes the aperture value to F5.6 (the Av value is 5), resulting in the screen display appears as shown in FIG. 9B.

(2) When the Av Value is Higher than the Available Setting Range which Provides the Appropriate Exposure

Next, the operation of the controller 150 will be described which is performed when the recording mode is the A mode and the aperture value is set to the value higher than the range which can provide the appropriate exposure. It is assumed that the target Ev value is 2 and the aperture value set by the user is F22 (the Av value is 9). Avmax, Avmin, Tvmax, and Tvmin corresponding to the target Ev value of 2, are 8, 4, −2, and −6, respectively. Therefore, the Av value set by the user, 9, is higher than the range. First, the controller 150 obtains the Tv value (the Tv value is −6) which causes the current Ev value to be closest to the target Ev value from the diagram of FIG. 6. The Tv value is found in the same way as the Tv value as described above. The Tv value is found also in the same way below. Since the obtained Ev value (=3) is higher than the target Ev value (=2), and thus the underexposure occurs. At that time if the controller 150 detects that the function button is pressed in the above described occasion, the controller 150 changes the Av value to fulfill both the target Ev value and the above described obtained Tv value. In this case, (Av value)=(target Ev value)−(Tv value)=2−(−6)=8, and thus the Av value is changed from 9 to 8 (S306 of FIG. 7).

The above described appropriate exposure setting operation brings the Av value to 8 and the Tv value to −6, which makes the obtained Ev value (=2) equal to the target Ev value (=2), resulting in the appropriate exposure.

### 2-3-2. Appropriate Exposure Setting Operation in S Mode

(1) When the Tv Value is Lower than the Available Setting Range which Provides the Appropriate Exposure

Next, the operation of the controller 150 will be described which is performed when the recording mode is the S mode and the shutter speed is set to the value slower (smaller in Tv value) than the range which can provide the appropriate exposure. It is assumed that the target Ev value is 14 and the shutter speed set by the user is 4 (the Tv value is −2). Avmax, Avmin, Tvmax, and Tvmin corresponding to 14 of the target Ev value are 9, 4, 10, and 5, respectively. Therefore, the Tv value set by the user, −2, is lower than the range. First, the controller 150 obtains the Av value which causes the current Ev value to be closest to the target Ev value (the Av value is 9) with reference to the diagram of FIG. 6 (S404 of FIG. 8). At this time, the obtained Ev value (=7) is lower than the target Ev value (=14), and thus the overexposure occurs. If the controller 150 detects that the function button is pressed, the controller 150 changes the Tv value to fulfill both the target Ev value and the obtained Av value. In this case, since (Tv value)=(target Ev value)−(Av value)=14−9=5, the Tv value is changed from −2 to 5 (S406 of FIG. 8).

The above described appropriate exposure setting operation brings the Tv value to 5 and the Av value to 9, which makes the obtained Ev value (=14) equal to the target Ev value (=14), resulting in the appropriate exposure.

(2) When the Tv Value is Higher than the Available Setting Range which Provides the Appropriate Exposure

Next, the operation of the controller 150 will be described which is performed when the recording mode is the S mode and the shutter speed is set to the value faster (larger in Tv value) than the range which can provide the appropriate exposure. It is assumed that the target Ev value is 14 and the user-set shutter speed is 1/4000 (the Tv value is 12). Avmax, Avmin, Tvmax, and Tvmin corresponding to the target Ev value, 14, are 9, 4, 10, and 5, respectively. Therefore, the Tv value set by the user, 12, is higher than the range. First, the controller 150 obtains the Av value which causes the current Ev value to be closest to the target Ev value (the Av value is 4) from the diagram as shown in FIG. 6 (S404 of FIG. 8). The obtained Ev value (=16) is higher than the target Ev value (=14), and thus the underexposure occurs. If the controller 150 detects that the function button is pressed, the controller 150 changes the Tv value to fulfill both the target Ev value and the obtained Av value. In this case, since (Tv value)=(target Ev value)−(Av value)=14−4=10, the Tv value is changed from 12 to 10 (S406 of FIG. 8).

The above described appropriate exposure setting operation brings the Tv value to 10 and the Av value to 4, which makes the obtained Ev value (=14) equal to the target Ev value (=14), providing the appropriate exposure.

As the examples shown in the previous case and this case, the appropriate exposure setting operation has different results according to the shooting parameter (shutter speed) set by the user even if the target Ev value is the same (14). As a result, the appropriate exposure setting operation is required to cause the change in the shooting parameter set by the user to be minimum. Therefore, the appropriate exposure setting operation provides the shooting parameter as close as possible to the setting intended by the user within the setting range which provides the appropriate exposure.

### 3. Summary

As described above, the digital camera 100 of the embodiment has a CCD image sensor 120 for capturing an image of a subject to generate image data, a controller 150 for calculating a target Ev value based on the image data and controlling the exposure to obtain the target Ev value based on a shooting parameter set by a user (aperture value or shutter speed), and an operation section 180 for receiving operations of the user. The controller 150 calculates a range of the shooting parameter set by the user, for obtaining the target Ev value, and also calculates another shooting parameter (shutter speed or aperture value) based on the target Ev value and the shooting parameter set by the user. If a function button of the operation section 180 receives user's operation when the shooting parameter set by the user is out of the range for obtaining the target Ev value, the controller 150 performs an exposure control operation to change the shooting parameter set by the user to a value within an appropriate range.

According to the digital camera 100, even when the appropriate exposure cannot be obtained from a shooting parameter set by the user, the appropriate exposure can be automatically set by user's pressing the function button and a shooting parameter as close as possible to the setting intended by the user can be automatically obtained. That allows the user to obtain the appropriate exposure more easily and more quickly.

### 4. Other Embodiments

The digital camera 100 of the above described embodiment detects that the function button of the operation section 180 is pressed and accordingly performs the appropriate exposure setting operation. However, the method for the user to instruct the appropriate exposure setting operation is not limited to that. For example, the digital camera 100 may be adapted to display a predetermined icon on the display unit 170, detect that the user touches the icon, and performs the appropriate exposure setting operation according to the detection. Alternatively, the digital camera 100 may adapted to be able to assign the function of the appropriate exposure setting operation to a certain button.

Further, the digital camera 100 may be adapted to perform a so-called “undo” or “recover” operation. For example, when the digital camera 100 detects that the function button is pressed to perform the appropriate exposure setting operation and then another pressing of the function button is done (without any other operation), the controller 150 returns the shooting parameter to that in the state before the appropriate exposure setting operation is performed. Alternatively, the digital camera 100 may also be adapted to perform the “undo” or “recover” operation, when detecting that the function button is secondary pressed, after the function button is firstly pressed to perform the appropriate exposure setting operation and until the exposure setting is changed.

The digital camera 100 of the above described embodiment detects that the function button of the operation section 180 is pressed and performs the appropriate exposure setting operation according to the detection. However, the digital camera 100 may be adapted as below. The digital camera 100 may be adapted to perform the appropriate exposure setting operation before taking a photograph when the release button of the operation section 180 is pressed (full-press or half-press). With this arrangement, it is possible to perform the recording operation after the appropriate exposure setting operation only by pressing the release button, without pressing the function button before the recording operation, allowing the user operation to be easier. In this case, it is preferable to allow the user to set, on a menu and so on, whether to perform the appropriate exposure setting operation before taking a photograph when the user presses the release button. The operation in this case differs from that in the P mode or the like, as described below. In the P mode, the digital camera 100 performs all of the exposure setting. However when the appropriate exposure setting operation is performed in the A mode or in the S mode, the exposure setting made by the user in advance is reflected in the operation to some extent. For example, even in the case where the user opens the aperture at maximum in the A mode which causes the overexposure, by user's pressing the release button, the aperture value can be changed to cause the aperture to be as close as possible to the open end within the range which can provide the appropriate exposure, so that the user's intention can be reflected to the setting.

The digital camera 100 of the above described embodiment detects that the function button of the operation section 180 is pressed and performs the appropriate exposure setting operation according to the detection. However, the digital camera 100 may be adapted otherwise as below. The digital camera 100 may be adapted to perform the appropriate exposure setting operation when the user operates the ISO sensitivity or the exposure correction.

Although exposure correction is not referred to in the above described embodiment, the digital camera 100 may have an exposure correction function. With the exposure correction function, when the user operates the operation section 180 to set an exposure correction set value, the target brightness value is corrected based on the set value. Specifically, when the exposure correction set value is set to a positive value (i.e., set to make the final image data brighter), the target brightness value is corrected to be higher according to the absolute value of the set value. In contrast, when the exposure correction value is set to a negative value (i.e., set to make the final image data darker), the target brightness value is corrected to be lower according to the absolute value of the set value. The other operations are the same as those in the embodiment described above.

Although the digital camera 100 of the above described embodiment has the ISO sensitivity fixed to a value set by the user, the digital camera 100 may be adapted to control the ISO sensitivity in the exposure controlling. For example, the digital camera 100 can increase the target Ev value by 1, by increasing the ISO sensitivity by one step. Therefore, if the current Ev value is 13, the target Ev value is 12, and the ISO sensitivity is 100, for example, the digital camera 100 can make the target Ev value to 13 by increasing the ISO sensitivity by one step to make the ISO sensitivity 200, so that the appropriate exposure is obtained without changing the Av value or the Tv value. However, there may be a case where the appropriate exposure cannot be obtained within the available setting range of ISO for the shooting parameter set by the user. Even in such a case, with the function button pressed, the digital camera 100 can perform the appropriate exposure setting operation as described in the above embodiment with the ISO sensitivity kept the current value.

In the appropriate exposure setting operation of the above described embodiment, only the shooting parameter set by the user is changed to cause the shooting parameter set by the user to be within the available setting range if the shooting parameter set by the user is out of the available setting range for providing the target EV value. However, the embodiment is not limited to that. The other methods for changing the shooting parameter set by the user to the value within the available setting range may be used. For example, both the aperture value and the shutter speed may be changed to make the aperture value minimum (aperture is more opened) within the available setting range.

For the digital camera 100 of the above described embodiment, although the available setting range of aperture value is assumed to be from F4 to F22 and the available setting range of shutter speed is assumed be from 60 seconds to 1/4000 seconds, these are merely examples and the available setting ranges are not limited to those. The idea of the embodiment can be applied to a digital camera with any available setting range.

Although the digital camera with lenses incorporated in the camera body is described in the above described embodiment, the idea of the embodiment can be applied even to a camera mountable with interchangeable lens.

### 5. Terminology

The COD image sensor 120 is an example of the imaging unit. The controller 150 is an example of the controller. The digital camera 100 is an example of the imaging apparatus. The aperture value and the shutter speed are examples of the first and second shooting parameters.

### INDUSTRIAL APPLICABILITY

According to the aforementioned embodiment, the appropriate exposure setting can be more easily obtained, and the appropriate exposure setting can be quickly performed. Therefore, the aforementioned embodiment is useful for imaging apparatus such as a digital camera or a video camera having a function of enabling a user to set the exposure.

What is claimed is:

1. An imaging apparatus comprising:
an imaging unit configured to capture an image of a subject to generate image data;
a controller configured to calculate a target exposure value based on the image data and control an exposure to obtain the target exposure value based on a first shooting parameter set by a user; and
a predetermined operation member for receiving operation of the user, wherein
the controller
calculates a first appropriate range which is a range in which the first shooting parameter is settable for obtaining the target exposure value,
calculates a second shooting parameter based on the target exposure value and the first shooting parameter set by the user, and
performs an exposure control operation for setting the first shooting parameter within the first appropriate range, when the predetermined operation member receives the user operation when the first shooting parameter set by the user is out of the first appropriate range.

2. The imaging apparatus according to claim 1, wherein the first shooting parameter is one of an aperture value and a shutter speed and the second shooting parameter is the other of the aperture value and the shutter speed.

3. The imaging apparatus according to claim 1, wherein when the first shooting parameter set by the user is out of the first appropriate range, the controller calculates the second shooting parameter so that an exposure value based on the first shooting parameter set by the user and the second shooting parameter is closest to the target exposure value.

4. The imaging apparatus according to claim 1, wherein
the predetermined operation member is a release button, and
when the release button is half pressed, the exposure control operation is performed.

5. The imaging apparatus according to claim 1, wherein
the predetermined operation member is a touch panel, and
when the touch panel is operated, the exposure control operation is performed.

6. The imaging apparatus according to claim 1, wherein when an ISO sensitivity setting is changed, the controller performs the exposure control operation.

7. The imaging apparatus according to claim 1, wherein when an exposure correction setting is changed, the controller performs the exposure control operation.

8. The imaging apparatus according to claim 1, wherein
the controller
calculates a second shooting parameter based on the target exposure value and the first shooting parameter set by the user, and
sets the first and second shooting parameters so that the first shooting parameter is within the first appropriate range and to minimize the aperture value, when the predetermined operation member receives the user operation and the first shooting parameter set by the user is out of the first appropriate range.

9. An imaging apparatus comprising:
an imaging unit configured to capture an image of a subject to generate image data;
are operation section configured to receive a user operation;
a memory storing information regarding a relationship between parameters including exposure values, aperture values, and shutter speed and instructions; and
a controller executing the instructions stored in the memory, the instructions configuring the controller to:
determine a target exposure value based on the image data;
if the user operation is indicative of a predetermined function, replace a parameter input by the user to achieve the target exposure,
if the user operation is not indicative of the predetermined function, determine one or more parameters other than that input by the user so that an effective exposure is as close as possible to the target exposure value based upon the information regarding the relationship between exposure values, aperture values, and shutter speed.
